(19) United States
(12) Patent Application Publication
(10) Pub. No.: US 2020/0108509 A1
(43) Pub. Date: Apr. 9, 2020

(54) GRIPPING DEVICE WITH NEEDLES FOR DEFORMABLE FOOD PRODUCT

(71) Applicant: BEL, SURESNES (FR)

(72) Inventors: Patrice HUMBERT, VILLETRUN (FR); Lionel BEQUIN, VENDOME (FR); Laurent LE CALLOCH, BOUESSAY (FR); Pascal LE SENECHAL, COULOMMIERS (FR)

(21) Appl. No.: 16/618,060

(22) PCT Filed: Jun. 1, 2018
(86) PCT No.: PCT/EP2018/064525

§ 371 Date: Nov. 27, 2019

(30) Foreign Application Priority Data
Jun. 1, 2017 (FR) 17 54856

(51) Int. Cl. B25J 11/00; B25J 15/00; B65G 47/91; B65B 5/06; B65B 25/06; B65B 35/36; A23P 20/20; A23C 19/16; A23C 19/09

(52) U.S. Cl. CPC B25J 11/0045; B25J 15/0071; B65G 47/91; B65B 5/068; B65B 25/061; B65G 2207/26; A23P 20/20; A23C 19/16; A23C 19/0908; B65G 2201/0202; B65B 35/36

(57) ABSTRACT

A gripping device for at least one deformable food product has at least one perforated plate defining at least one receiving surface for the deformable food product, and for each receiving surface, a pair of needles associated with the receiving surface. Each needle of the pair is able to be moved between a retracted position, in which the needle does not pass through the receiving surface, and a deployed position, in which the needle passes through the receiving surface. A facility has the gripped device for producing deformable food products, and a method for moving a deformable food product uses the gripping device.

### PRIORITY AND CROSS REFERENCE TO RELATED APPLICATIONS

This application is the U.S. National Phase Application under 35 U.S.C. § 371 of International Application No. PCT/EP2018/064525, filed Jun. 1, 2018, designating the U.S. and published as WO 2018/220208 A1 on Dec. 6, 2018, which claims the benefit of French Application No. FR 17 54856, filed Jun. 1, 2017. Any and all applications for which a foreign or a domestic priority is claimed is/are identified in the Application Data Sheet filed herewith and is/are hereby incorporated by reference in their entireties under 37 C.F.R. § 1.57.

### FIELD

The present invention relates to gripping devices for deformable food products.

### SUMMARY

The present invention relates to a gripping device for at least one deformable food product. The invention also relates to a facility for producing deformable food products comprising such a gripping device, and a method for moving a deformable food product using such a gripping device.

This gripping device is more particularly suitable for picking up and depositing at least one deformable food product that may be soft and/or sticky on a fast-paced agri-food production line.

### BRIEF DESCRIPTION OF THE DRAWINGS

The features and advantages of the invention will appear in light of the following description, provided solely as a non-limiting example and done in reference to the appended drawings, in which:

FIG. 1 is a general top view of a production facility according to the invention,

FIG. 2 is a perspective view of a deformable food product produced by the facility of FIG. 1,

FIG. 3 is an elevation view of a gripping device of the production facility of FIG. 1,

FIG. 4 is a perspective bottom view of the gripping head of the gripping device of FIG. 3,

FIG. 5 is a perspective bottom view of a perforated plate of the gripping head of FIG. 4,

FIG. 6 is a perspective top view of the perforated plate of FIG. 5,

FIG. 7 is a perspective bottom view of a detail of FIG. 4, a perforated plate of the gripping head having been removed,

FIG. 8 is a sectional view, along the plane marked VIII-VIII in FIG. 4, of the gripping head of FIG. 4,

FIG. 9 is a sectional view, along the plane marked XI-XI in FIG. 4, of the gripping head of FIG. 4, a pricking system of the gripping head being in a retracted configuration,

FIG. 10 is a view of a detail marked X in FIG. 9, the pricking system being in a deployed configuration, and

FIG. 11 is a perspective top view of the gripping head of FIG. 4.

### DETAILED DESCRIPTION

Gripping devices for deformable food products are known.

Thus, a gripping device for deformable food products is for example known from WO2007/046715 A1 comprising a plurality of pairs of needles. This type of device is suitable for gripping food products that hold together, such as meat or fish. The products are handled frozen, which makes them easier to hold and decreases the sticking or deconstruction phenomena of the food product. However, this device is not suitable for gripping food products that are handled unfrozen, or even at positive temperatures. Indeed, such food products are deformable, soft and sticky, and would stick to such a gripper, causing dirtying phenomena and therefore hygiene problems.

Also known from JP2005333827 is a device for gripping a deformable food product, comprising at least one pair of needles. Here again, this type of gripper is not suitable for gripping deformable, soft and sticky food products. It in fact becomes dirty quickly and does not allow clean and quick depositing, at a fast pace, without alteration of the food product.

Lastly, known from FR 2,997,031 is a device for gripping a plurality of deformable food products, comprising a perforated plate defining a plurality of surfaces for receiving food products, and a suction system for pressing the food products against the receiving surfaces by suction effect. Such a device has several drawbacks:

rapid dirtying by the food product during the suction phase and/or sticking during deposition;

difficulty cleaning the device;

substantial losses by sticking and deconstruction of the food product during its deposition, for example in the case of wraps including a cheese filling surrounded by a food sheet of the charcuterie type, the wrap unwinding during blowing;

need for all of the food products to have a very standardized shape to ensure effective gripping; indeed, when the shape of one of the gripped food products deviates from the standard, the gripping by suction against the receiving surface is altered and causes pressure losses, the detachment of the food product before it is deposited, or even the absence of gripping of the food product.

One aim of the invention thus consists of allowing the gripping, in an automated and fast-paced manner, of at least one fragile, deformable, soft and sticky food product, while limiting the dirtying and deformation, or even deconstruction, phenomena of said food product, in particular when this food product comprises an outer envelope made from a first food material and an inner filling made from a second food material. Another aim consists of promoting the cleanability of the gripping device used to that end.

To that end, the invention relates to a gripping device for at least one deformable food product, comprising

at least one perforated plate defining at least one receiving surface for the deformable food product, and

for the or each receiving surface, a pair of needles associated with said receiving surface, each needle of said pair being able to be moved between a retracted position, in which the needle does not pass through the receiving surface, and a deployed position, in which the needle passes through the receiving surface.

According to specific embodiments of the invention, the gripping device also comprises one or more of the following features, considered alone or according to any technically possible combination(s):

the receiving surface is convex;

the gripping device comprises a blowing system able to blow gas through the or each receiving surface,

the blowing is done in the form of compressed air, preferably in the form of filtered compressed air,

the blowing is sufficient to loosen the or each deformable food product from the receiving surface,

the or each perforated plate has, for the or each receiving surface defined by said perforated plate, at least two through orifices each emerging in said receiving surface, each needle of the pair associated with this receiving surface extending, when it is in the deployed position, through a respective through orifice among said through orifices,

the blowing system is able to blow air through said through orifices,

the blowing system comprises, for each receiving surface, at least one blowing nozzle emerging near through orifices emerging in said receiving surface, each blowing nozzle preferably having a diameter smaller than 5 mm,

the blowing system comprises a pressurized gas supply system, able to supply a gas at a pressure of between 1 bar and 3 bars, for example between 1 bar and 2.5 bars,

the receiving surfaces are a plurality, at least one blowing nozzle being positioned substantially equidistant from a first through orifice emerging in a first of said receiving surfaces and a second through orifice emerging in a second of said receiving surfaces,

the or each receiving surface is elongated along a main direction, and the blowing nozzles comprise at least two blowing nozzles framing, along a direction orthogonal to the main direction, the through orifices emerging in said receiving surface,

each needle is mounted rotating around a rotation axis relative to the perforated plate between its retracted and deployed positions, each needle further being in the shape of an arc of circle centered on said rotation axis,

the rotation axes of the two needles of a same pair are substantially parallel to one another, the rotation direction of a first needle of the pair from its retracted position toward its deployed position being opposite the rotation direction of the second needle of the pair from its retracted position to its deployed position,

there is a straight line substantially parallel to the rotation axes of the needles of a same pair such that, when said needles are in the deployed position, this line passes through said needles, and

each needle has a diameter smaller than or equal to 5 millimeters, preferably smaller than or equal to 2 millimeters.

The invention also relates to a facility for producing deformable food products each comprising an outer envelope made from a first food product and an inner filling made from a second food product, the facility comprising:

a station for supplying a sheet of first food material,

a system for supplying a roll of second food material,

a station for wrapping the sheet around the roll,

a station for cutting the roll and the sheet wrapped around into a plurality of segments each forming a deformable food product, and

a station for packaging deformable food products, comprising a gripping device as previously defined for gripping deformable food products and depositing said deformable food products into containers.

The invention further relates to a method for moving a deformable food product using a gripping device as previously defined, comprising the following successive steps:

bringing a receiving surface above the deformable food product,

deploying the pair of needles associated with the receiving surface, the needles penetrating into the deformable food product,

moving the gripping device, and

retracting said pair of needles.

According to specific embodiments of the invention, the method for moving also has one or more of the following features, considered alone or according to any technically possible combination(s):

the deformable food product comprises an outer envelope made from a first food product and an inner filling made from a second food product;

the envelope and the filling do not have the same textures or the same mechanical properties;

the first food material is made up of:
a slice of meat, in particular a salted product, in particular a slice of ham, for example smoked raw ham, or
a plant product, for example a slice of vegetable or a leaf of vegetable purée, or
a cheese product, for example a pressed cheese, a re-textured cheese or a stretched cheese, or
a seafood product, for example a slice of fish, a slice of smoked fish, a salted fish product, a sheet of seaweed, or
a product with a base of seaweed, fish, shellfish or a mixture thereof;

the second food product is essentially made up of soft cheese;

the soft cheese is a fresh cheese, a melted cheese, a melted fresh cheese, or a stretched cheese;

the second food material comprises at least one input mixed with the soft cheese, the or each input being chosen from among: seasonings, herbs, fruits, nuts, vegetables, spices, flavorings, dyes; and

the food product is made up of a small cheese of the portion type, for example a string cheese or a wound string cheese.

Other features and advantages of the invention will appear in light of the following description, provided solely as a non-limiting example and done in reference to the appended drawings, in which:

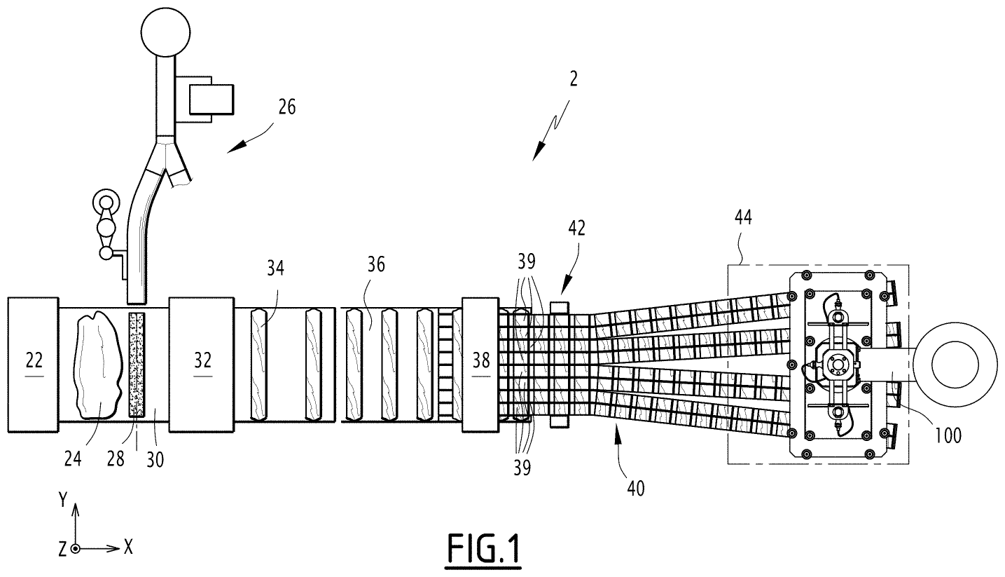

FIG. 1 is a general top view of a production facility according to the invention,

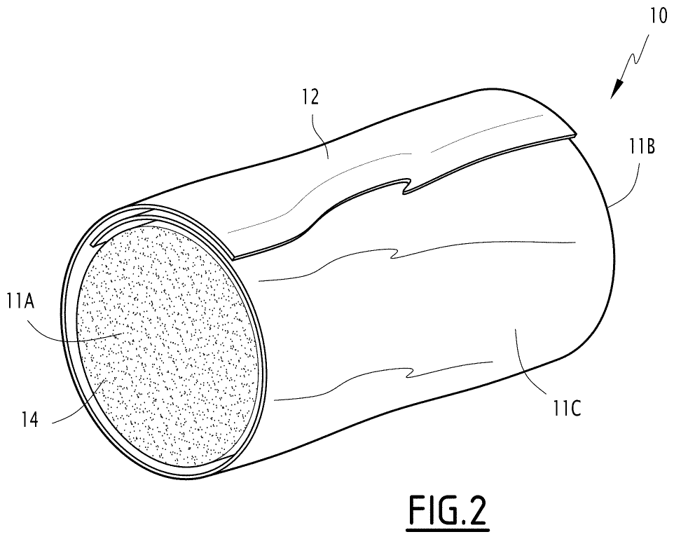

FIG. 2 is a perspective view of a deformable food product produced by the facility of FIG. 1,

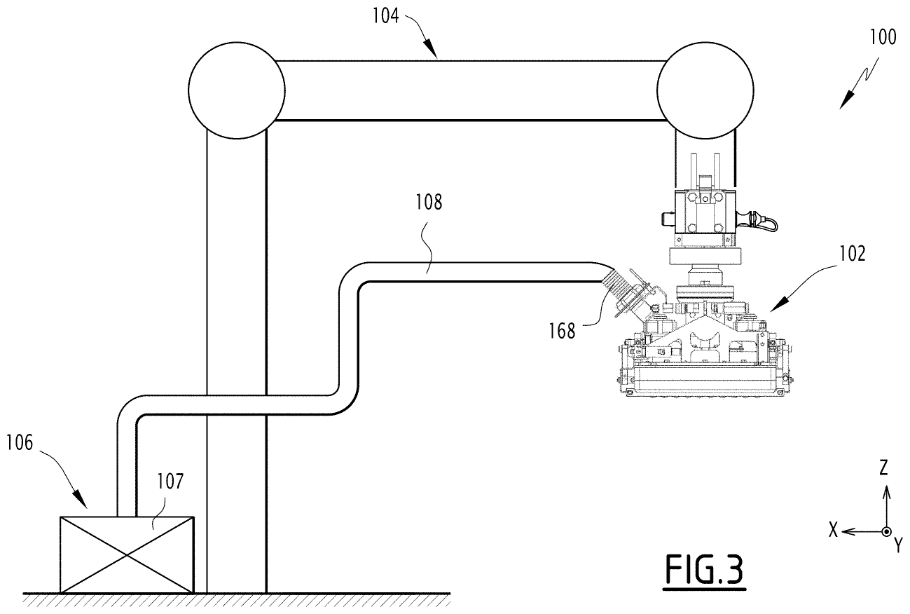

FIG. 3 is an elevation view of a gripping device of the production facility of FIG. 1,

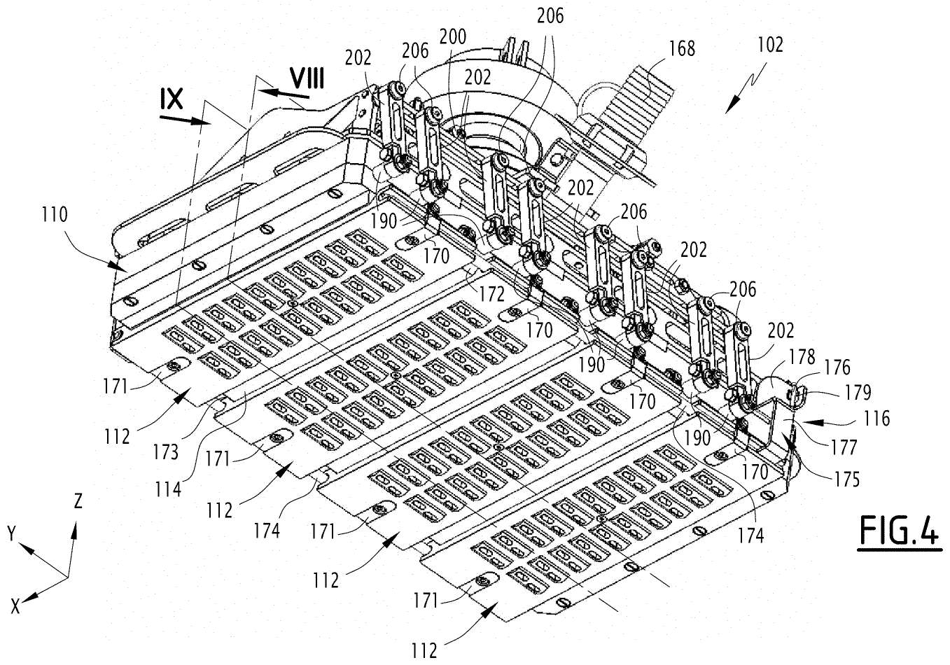

FIG. 4 is a perspective bottom view of the gripping head of the gripping device of FIG. 3,

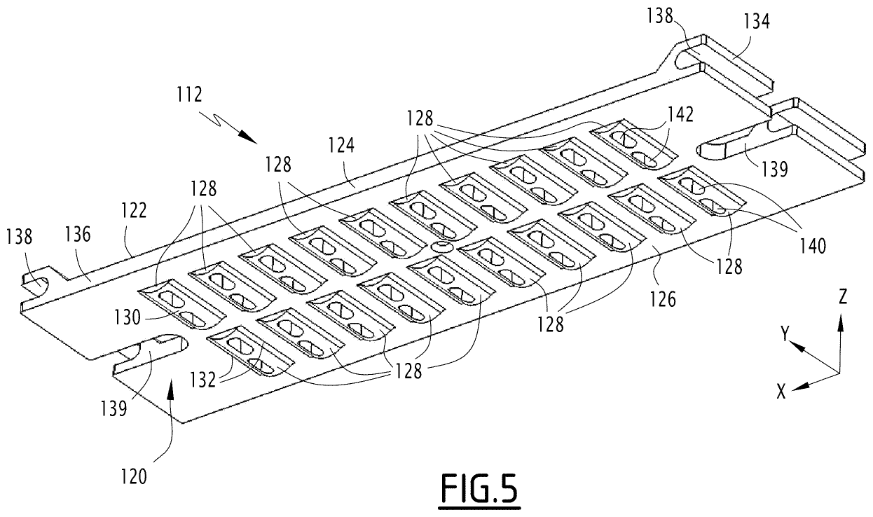

FIG. 5 is a perspective bottom view of a perforated plate of the gripping head of FIG. 4,

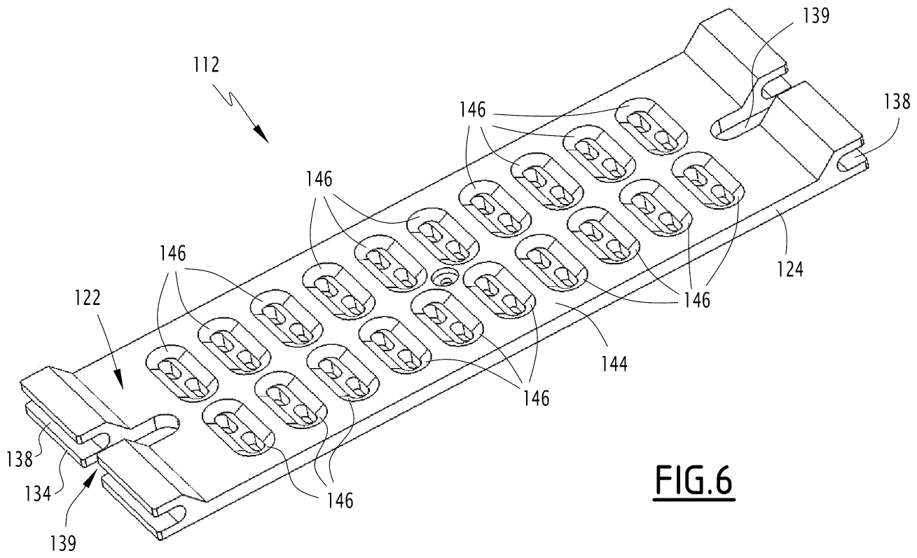

FIG. 6 is a perspective top view of the perforated plate of FIG. 5,

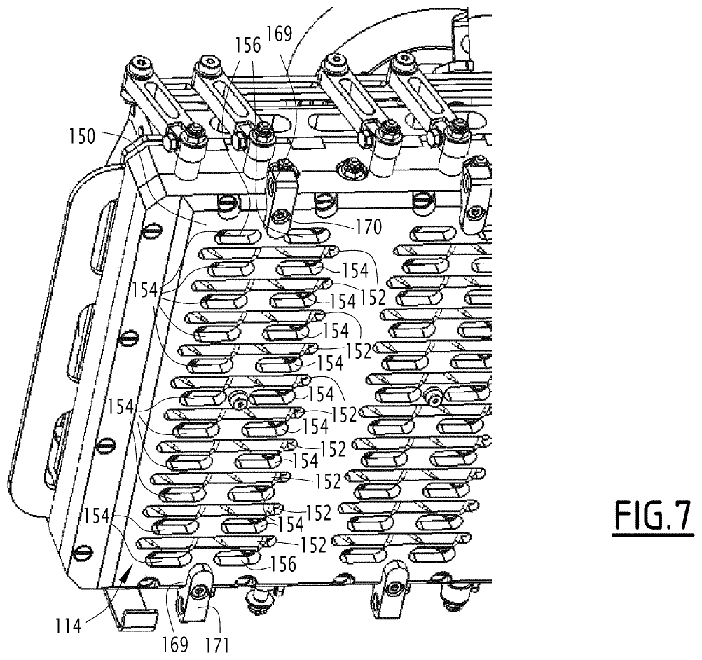

FIG. 7 is a perspective bottom view of a detail of FIG. 4, a perforated plate of the gripping head having been removed,

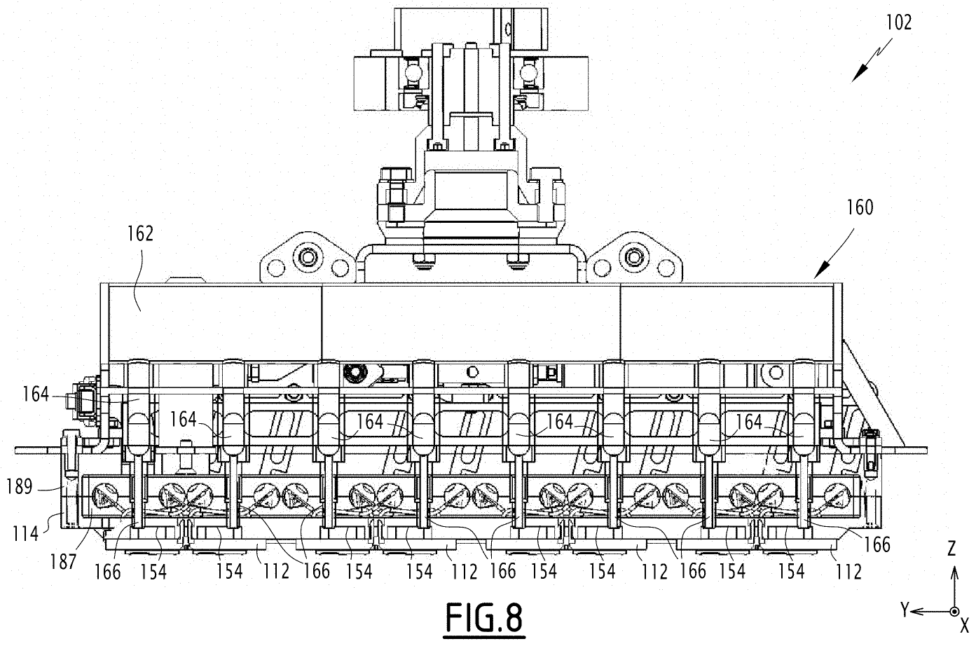

FIG. 8 is a sectional view, along the plane marked VIII-VIII in FIG. 4, of the gripping head of FIG. 4,

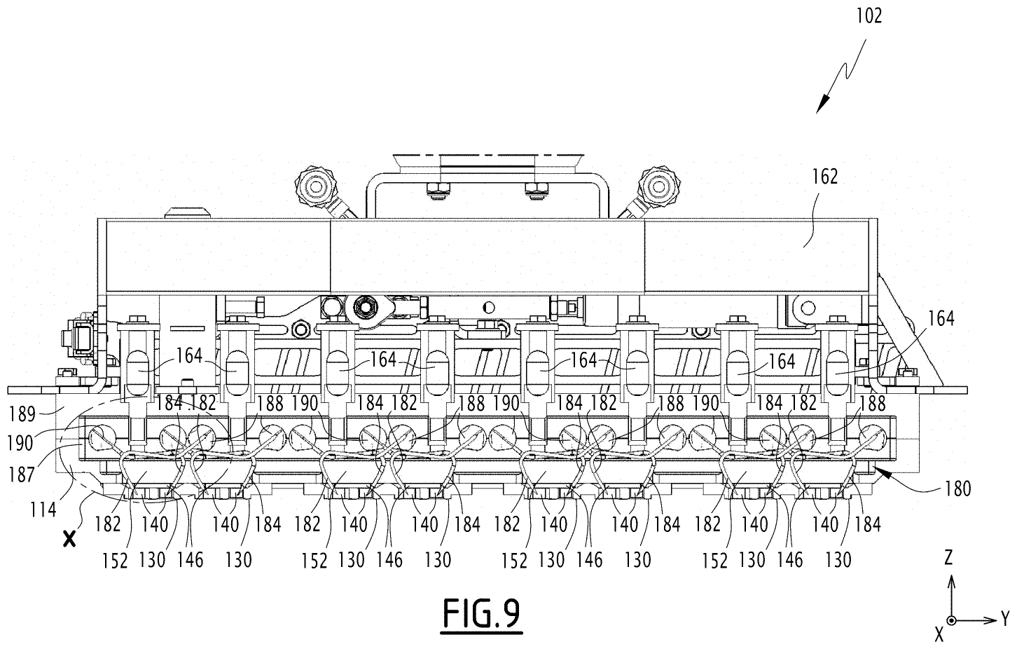

FIG. 9 is a sectional view, along the plane marked XI-XI in FIG. 4, of the gripping head of FIG. 4, a pricking system of the gripping head being in a retracted configuration,

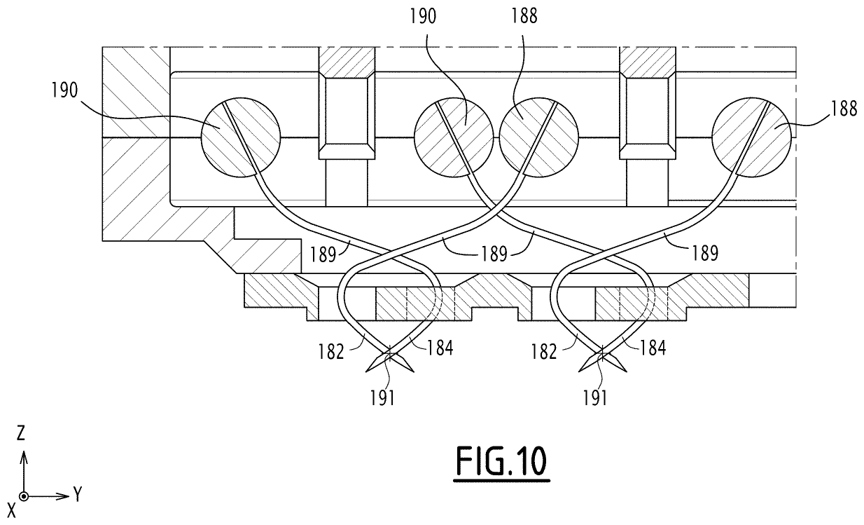

FIG. 10 is a view of a detail marked X in FIG. 9, the pricking system being in a deployed configuration, and

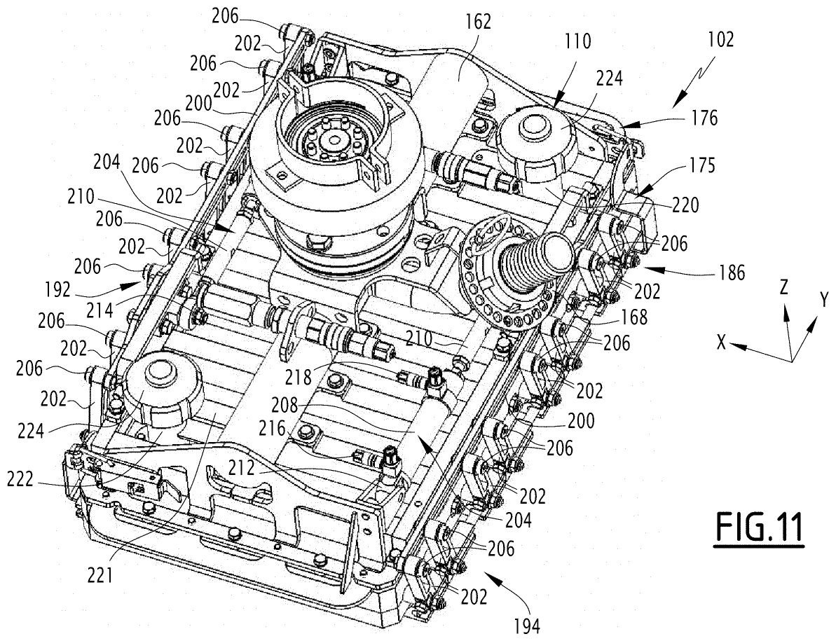

FIG. 11 is a perspective top view of the gripping head of FIG. 4.

The production facility 2 visible in FIG. 1 is suitable for producing food products such as the filled food 10 shown in FIG. 2.

In reference to this FIG. 2, the filled food 10 is substantially cylindrical of revolution. It has two bases 11A, 11B each defining an axial end of the filled food 10, and a peripheral side face 11C connecting the bases 11A, 11B to one another. It typically has a diameter of between 1 and 3 cm, and a length of between 2 and 8 cm.

The filled food 10 comprises an outer envelope 12 made from a first food product and an inner filling 14 made from a second food product.

The outer envelope 12 is tubular. It defines the peripheral side surface 11C of the filled food 10. It does not cover the axial ends of the filled food 10. Seen from the axial end of the filled food 10, it forms a spiral around the inner filling 14.

The first food material is typically meat, particularly a salted product, and preferably ham. In a variant, the first food product is a plant product, for example a slice of vegetable or leaf of vegetable purée. In another variant, the first food material is a cheese product, for example a pressed cheese, a re-textured cheese or a stretched cheese. In still another variant, the first food material is a seafood product, for example a slice of fish, a slice of smoked fish, a salted fish product, a sheet of seaweed, or a product with a base of seaweed, fish, shellfish or a mixture thereof.

The inner filling 14 forms a solid cylinder. It is flush with the axial ends of the filled food 10.

The second food material that makes up this filling 14 has a penetrometry index of between 80 and 300. It is advantageously a shear thinning product having a consistency of between 800 and 1200 Pa·s at 12° C., with a shear thinning index between 0.10 and 0.20.

An example of second food material having these characteristics is when the second food material is a cheese product essentially made up of cheese, that is to say, the cheese makes up more than 70% by weight of the cheese product. This cheese is typically a soft cheese according to the definition given by the CODEX STAN 283-1978, that is to say, a cheese whose water content of the fat-free cheese (MFFB) is greater than 67%, said MFFB being calculated as follows: (Weight of the water in the cheese)/(Total weight of the cheese−Weight of the fat content in the cheese).

In one embodiment, the cheese product comprises at least one input mixed with the cheese, the or each input being chosen from among: seasonings, herbs, fruits, nuts, vegetables, spices, flavorings, dyes.

The second food material also has a density of between 0.9 and 1.

Back to FIG. 1, the facility 2 comprises a station 22 for supplying a sheet 24 of the first food material, a system 26 for supplying a roll 28 of the second food material, and a belt 30 for driving the sheet 24 and the roll 28. The facility 20 also comprises a station 32 for wrapping the sheet 24 around the roll 28 in order to form a large wrap 34, and a belt 36 for storing large wraps 34. The facility 20 lastly comprises a station 38 for cutting each large wrap 34 into segments 39, a device 40 for driving and separating the segments 39, a system 42 for eliminating end segments 39, and a station 44 for packaging filled foods 10.

For the description of the supply station 22, the supply system 26, the production belt 30, the wrapping station 32, the storage belt 36, the cutting station 38, the driving device 40 and the elimination system 42, the reader is invited to refer to the description of these elements given by document FR 2,996,988 A1, the content of which is incorporated herein by reference.

Hereinafter, we will describe only the wrapping station 44. For this description, the orientation terms are to be understood relative to the direct orthogonal coordinate system defined hereinbelow, shown in the Figures, and in which one distinguishes:

a longitudinal axis X, oriented from upstream to downstream in the facility 20,

a transverse axis Y, oriented from right to left in the facility 20, and

a vertical axis Z, oriented from bottom to top.

The wrapping station 44 is arranged at the downstream end of the facility 20. It comprises a gripping device 100 according to the invention for gripping food products on the central belts of the driving device 40, and depositing said food products in trays (not shown).

In reference to FIG. 3, the gripping device 100 comprises a gripping head 102 and a robotic arm 104 for moving the gripping head 102. It also comprises a system 106 for insufflating pressurized gas, typically pressurized air, in the gripping head 102.

The insufflation system 106 comprises a system 107 for supplying pressurized gas, typically an air compressor, and a fluid pipe 108 fluidly connecting the supply system 107 to the gripping head 102.

The supply system 107 is suitable for supplying a pressurized gas between 1 bar and 3 bars, for example between 1 bar and 2.5 bars, and preferably substantially equal to 2 bars. The compressed air consumption here is reduced relative to blowing solutions known from the state of the art. This results in a decrease in the number of decibels generated by the facility and substantial energy savings.

As shown in FIG. 4, the gripping head 102 comprises a body 110, a plurality of perforated plates 112 pressed against a lower wall 114 of the body 110, and a system 116 for fastening the plates 112 to the body 110.

The body 110 has a generally parallelepiped shape. It is elongated in the transverse direction Y.

The body 110 is typically made from high-density polyethylene (HDPE). Owing to the use of this material, a long lifetime of the body 110 is guaranteed, since HDPE withstands cool environments very well, typically with a temperature below 8° C., and the aggressive cleaning products used in the agri-food industry. Thus the parts do not deform, in particular during cleaning. Furthermore, HDPE is lightweight, in particular lighter than stainless steels, which makes it possible to use, for the robotic arm 104, a robotic arm with relatively low power, which is therefore inexpensive and consumes little energy.

The perforated plates 112 are juxtaposed relative to one another along the transverse direction Y, each one being elongated along the longitudinal direction X. In the illustrated example, there are four of them.

Each perforated plate 112 is made from a material compatible with the food products, typically HDPE. Thus, the perforated plates do not deform during washing in line.

In reference to FIG. 5, each perforated plate 112 has a large lower face 120, oriented away from the body 110, a large upper face 122 bearing against the body 110, and a peripheral edge 124 forming the junction between the large lower face 120 and the large upper face 122.

The large lower face 120 has a substantially flat base 126 and a plurality of bosses 128 protruding downward, away from the large upper face 122, relative to the base 126.

The bosses 128 are arranged in a grid of rows and columns; in other words, each boss 128 is aligned in a first direction with at least one other boss 128 of a same column and in a second direction with at least one other boss 128 of a same row. The columns here are longitudinal and the rows are transverse. In the illustrated example, there are two columns and ten rows.

Each boss 128 defines a receiving surface 130 for a food product, able to receive a single food product at a time. This receiving surface 130 is convex. In particular, the receiving surface 130 is elongated along the transverse direction Y and is in the shape of a cylinder portion of revolution oriented transversely and advantageously, as shown, having two opposite parallel edges 132 that are flush with the base 126.

The fact that the receiving surface 130 is convex reduces the contact area between this surface 130 and the food product. The sticking phenomena causing the deconstruction or even unwinding of the food product are thus considerably reduced. Furthermore, this small contact area prevents the food product from being deformed, and limits the risks of contamination of the food product by the receiving surface 130.

The edge 124 has two end faces 134, only one of which is visible in FIG. 5, positioned at the longitudinal ends of the perforated plate 112, and two side faces 136, only one of which is visible in FIG. 5, defining the lateral ends of the perforated plate 112.

Each end face 134 defines a horizontal slot 138, emerging in each of the side faces 136. Furthermore, a notch 139 is arranged in each end face 134, substantially in the middle of said end face 134, the notch 139 having a depth greater than the slot 138 and emerging in the lower 120 and upper 122 faces.

The depth of each of the slots 138 and notches 139 is defined as being the distance from the bottom of said slot 138 or notch 139 to the end face 134 in which it is arranged.

Each perforated plate 112 also has a plurality of through orifices 140 each emerging in the upper face 122 and in the lower face 120, more particularly in one of the receiving surfaces 130.

For each receiving surface 130, the perforated plate 112 has two through orifices 140 emerging in said receiving surface 130. These two through orifices 140 each emerge through a respective opening 142 arranged in the receiving surface 130.

The openings 142 of these two orifices 140 each have an oblong shape elongated along the transverse direction Y. They are transversely offset relative to one another, in particular such that there is no longitudinal overlap between these openings 142. They are also longitudinally offset relative to one another, this offset being small, however, such that there is a transverse overlap between the openings 142.

In reference to FIG. 6, the upper face 122 has a substantially planar base surface 144, and a plurality of depressions 146, each hollow relative to the base surface 144.

The base surface 144 is in contact with the outer face 150 of the lower wall 114 of the body 110.

Each depression 146 is positioned in line with a corresponding boss 128, and the orifices 140 that emerge in this boss 128 emerge, on the upper face 122 side, in said depression 146. The depressions 146 are thus, like the bosses 128, positioned in a grid of rows and columns.

In reference to FIG. 7, the lower wall 114 of the body 110 has an outer face 150, against which the perforated plates 112 bear, and an inner face (not shown). The outer face 150 is substantially planar.

The inner wall 114 also has a plurality of windows 152, 154. These windows 152, 154 are in particular oblong, the direction of elongation being substantially combined with the transverse direction Y. They comprise first through windows 152, emerging in the outer face 150 and in the inner face, and second windows 154.

The first windows 152 are substantially identical to one another, and the second windows 154 are substantially identical to one another.

The first windows 152, respectively the second windows 154, are positioned in a grid of rows and columns. In other words, each first window 152, respectively each second window 154, is aligned in a first direction with at least one other first window 152, respectively another second window 154, in a same column, and along a second direction with at least one other first window 152, respectively another second window 154, in a same row. The columns here are longitudinal and the rows are transverse.

The first and second windows 152, 154 are positioned alternating with one another along the longitudinal direction X. Thus, for each pair of second windows 154 arranged successively along the longitudinal direction X, there is a first window 152 interposed longitudinally between said two second windows 154.

In particular, each first window 152 has a transverse length greater than twice the transverse length of the second windows 154, and the number of columns of first windows 152 is equal to half the number of columns of second windows 154, the middle of each column of first windows 152 being equidistant from two associated columns of second windows 154. As a result, each first window 152 belonging to a column of first windows 152 is interposed between two second windows 154 belonging to a first column associated with said column of first windows 152, and is also interposed between two second windows 154 belonging to a second column associated with said column a first windows 152.

Each first window 152 extends facing at least one associated depression 146 among the depressions 146 formed in the upper faces 122 of the plates 112, and each depression 146 formed in the upper face 122 of one of the plates 112 is associated with one of said first windows 152, that is to say, positioned facing said first window 152. In particular, for each first window 152, the depressions 146 associated with said first window 152 are constituted, as shown, by depressions 146 all belonging to a same plate 112 and aligned along a same transverse line, and all of the depressions 146 belonging to a same plate 112 and aligned along a same transverse line are associated with a same first window 152.

Each through orifice 140 is thus positioned facing one of said first through windows 152.

Each second window 154, with the exception of second end windows 156, that is to say, positioned at the longitudinal ends of a column, is in turn positioned straddling two associated depressions 146 among the depressions 146 formed in the upper faces 122 of the plates 112, that is to say, it extends partially facing each of said associated depressions 146. These depressions 146 associated with a same second window 154 are juxtaposed with one another along the longitudinal direction X.

Furthermore, each depression 146 formed in the upper face 122 of one of the plates 112 is associated with two of said second windows 154, that is to say, for each depression 146, two second windows 154 exist each extending partially facing said depression 146.

Regarding the second end windows 156, each one extends partially facing a single associated vacuum 146.

In reference to FIG. 8, the body 110 of the gripping head 102 comprises, aside from the lower wall 114, a guiding system 160 in order to guide the gas insufflated by the insufflation system 106 to the through orifices 140. This guiding system 160 thus forms, with the insufflation system 106, a blower system able to blow gas through each receiving surface 130, and in particular through each through orifice 140.

This guiding system 160 comprises a main distribution channel 162, a plurality of secondary distribution channels 164, and a plurality of blower nozzles 166. The guiding system 160 also comprises a coupler 168, visible in FIG. 4, for the fluid connection of the main distribution channel 162 to the insufflation system 106, in particular to the fluid pipe 108.

The main channel 162 is made up of a straight tube closed at its ends. It is oriented transversely, that is to say, its axis is substantially combined with the transverse direction Y. It extends over substantially the entire transverse width of the head 102 and is positioned substantially equidistant from the longitudinal ends of the head 102.

Each secondary channel 164 is fluidly coupled to the main channel 162.

Each secondary channel 164 is formed by a straight tube closed at its ends. It is oriented longitudinally, that is to say, its axis is substantially combined with the longitudinal direction X, and extends over substantially the entire longitudinal length of the head 102.

Each secondary channel 164 is able to supply pressurized gas to all of the second windows 154 in a same column. To that end, the number of secondary channels 164 is equal to the number of columns of second windows 154.

Each nozzle 166 extends from one of the secondary channels 164 and emerges in a respective second window 154. Furthermore, the number of nozzles 166 is equal to the number of second windows 154, so as to ensure the supply of pressurized gas of each second window 154.

Thus, for each receiving surface 130, two nozzles 166 emerge near through orifices 140 emerging in said receiving surface 130, said nozzles 166 longitudinally framing the receiving surface 130. Furthermore, by emerging in a second window 154, each nozzle 166, with the exception of the nozzles 166 emerging in the second end windows 156, emerges substantially equidistant from the through orifices 140 emerging in a first depression 146 associated with said second window 154, and therefore also in a first receiving surface 130, and through orifices 140 emerging in the second depression 146 associated with the second window 154, and therefore also in a second receiving surface 130.

Each nozzle 166 preferably has a diameter smaller than 5 mm. Thus, despite the relatively low pressure supplied by the supply system 107, the pressure contributed at the through orifices 140 emerging in each receiving surface 130 is sufficient to ensure loosening of the food product received on said receiving surface 130.

Returning to FIG. 4, the body 110 further comprises ribs 170, 171 for positioning the plates 112. Each rib 170, 171 protrudes downward relative to the outer face 150 of the lower wall 114 and is housed in a corresponding notch 139 of one of the plates 112.

Each rib 170, 171 is in particular elongated along the longitudinal direction X.

The positioning ribs 170, 171 comprises rear ribs 170, positioned along a rear edge 172 of the wall 114, and front ribs 171, positioned along a front edge 173 of the wall 114. The rear 170 and front 171 ribs are equal in number, each rear rib 170 being substantially longitudinally aligned with a corresponding front rib 171.

Each positioning rib 170, 171 further has a through opening 169 (FIG. 7) emerging in the two side faces of the rib 170, 171, said through opening 169 being positioned in the extension of the slot 138 arranged in the same end face 134 as that in which the notch 139 is arranged in which the rib 170, 171 is housed. The through openings 169 arranged in the rear ribs 170, respectively front ribs 171, are aligned with one another, so as to form a through passage.

The system 116 for attaching plates 112 comprises two rods 174, tongues 175 for retaining the rods 174, and attachments 176 for the tongues 175.

Each rod 174 is straight and oriented transversely, that is to say, its axis is substantially combined with the transverse direction Y. Each rod 174 is engaged in the transverse passage defined by the transverse openings 169 arranged in the positioning ribs 170, 171; each rod 174 is therefore also engaged in one of the slots 138 of each plate 112, and thus prevents the removal of the plates 112.

Each tongue 175 is integral with a respective rod 174. It comprises, starting from the rod 174, a first U-shaped segment 177, a second planar segment 178 in an arc of circle shape, and a third segment 179 protruding relative to the second segment 178.

The attachment 176 is in turn formed by a lever lock, the ring of which engages the third segment 179 of the tongue 175 when the lever lock is in the locked position, thus preventing the movement of the rod 174 in the transverse direction.

Owing to the fastening system 116, it is thus particularly easy to fasten the plates 112 to the body 110, and to remove them therefrom.

In reference to FIG. 9, the gripping head 102 also comprises a system 180 for gripping food products. This gripping system 180 comprises needles 182, 184 suitable for pricking the food products, and a system 186 (FIG. 11) for moving the needles 182, 184 between a position for pricking the food products and a position for releasing the food products.

Each needle 182, 184 is made from a material compatible with the food products, typically stainless steel.

There is an even number of needles 182, 184, said needles 182, 184 being distributed in pairs each associated with a respective receiving surface 130.

Each needle of a pair, respectively 182, 184, is secured to a rotation axis, respectively 188, 190, mounted rotating around its axis relative to the body 110. Each needle, respectively 182, 184, is thus mounted rotating around its rotation axis, respectively 188, 190, between a retracted position, in which it does not pass through the receiving surface 130 with which the pair is associated, and a deployed position, in which the needle 182, 184 passes through said receiving surface 130. In particular, when said needle 182, 184 is in the deployed position, it extends through a respective through orifice 140 among the through orifices 140 emerging in said receiving surfaces 130.

The retracted position constitutes the released position of the food products, and the deployed position constitutes the pricking position of the food products.

These needles 182, 184 and these axes 188, 190 are all mounted inside a common cavity 187 arranged inside the body 110 and defined between the lower wall 114 on the one hand, and an upper wall 189 on the other hand.

The rotation axes 188, 190 of all of the needles 182, 184 are longitudinal. Thus, within a same pair, the rotation axes of the two needles 182, 184 constituting said pair are parallel to one another.

Each needle, respectively 182, 184, is in the shape of an arc of circle centered on its rotation axis, respectively 188, 190. Thus, the penetration and removal of the needle 182, 184 in the food product are done along the same path, which avoids damaging the food product, in particular on the surface.

Furthermore, each needle 182, 184 has a diameter smaller than or equal to 2 mm, so as to limit the dent left by the needle 182, 184 in the food product due to its penetration.

When they are deployed, the needles 182, 184 of a same pair cross, as shown in FIG. 10; in other words, there is a straight line 191 substantially parallel to the rotation axes 188, 190 of the needles 182, 184 of a same pair such that, when said needles 182, 184 are in the deployed position, this line 191 passes through said needles 182, 184. These needles 182, 184 are, however, uncrossed when they are retracted, as shown in FIG. 9.

To that end, each pair comprises a first needle 182 and a second needle 184, one of which is symmetrical to the other relative to a longitudinal plane of symmetry (not shown), said needles 182, 184 further having symmetrical movements relative to said longitudinal plane. Thus, the rotation direction of the first needle 182 from its retracted position toward its deployed position is opposite the rotation direction of the second needle 184 from its retracted position toward its deployed position, and vice versa.

In particular, each first needle 182 of each pair is suitable for rotating in a first direction from its retracted position toward its deployed position, this first direction being the same for all of the first needles 182, and each second needle 184 of each pair is suitable for rotating in a second direction from its retracted position toward its deployed position, this second direction being the same for all of the second needles 184.

In the illustrated example, each needle 182, 184 is connected to its respective rotation axis 188, 190 by means of a bent rod 189. This bent rod 189 typically has a diameter substantially equal to the diameter of the needle 182, 184 and is preferably integral with the needle 182, 184.

In reference to FIG. 11, the movement system 186 comprises a first device 192 for driving the first needles 182, and a second device 194 for driving the second needles 184. The first driving device 192 is symmetrical with the second driving device 194 relative to a vertical axis of symmetry (not shown) substantially centered on the body 110; therefore, in order to simplify the description, only the second driving device 194 will be described hereinafter, the provided references also applying to the first driving device 192.

This second driving device 194 comprises a horizontal arm 200, a plurality of connecting rods 202 each mechanically connecting a respective second rotation axis 190 to the arm 200, and a jack 204 articulated to the body 110 of the head 102 and the arm 200.

The arm 200 is elongated along the transverse direction Y. It is suitable for moving in translation inside a transverse plane.

Each connecting rod 202 is secured to a respective second rotation axis 190, while being connected to the arm 200 by a pivot link 206 with longitudinal axis. The distance from the pivot link 206 to the respective second rotation axis 190 is the same for all of the connecting rods 202. As a result, the arm 200 is forced to retain a horizontal orientation.

The jack 204 is oriented transversely. It comprises a cylinder 208 and a piston 210. The cylinder 208 is connected to the body 110 by a first pivot link 212 with longitudinal axis. The piston 210 in turn is connected to the arm 200 by a second pivot link 214 with longitudinal axis.

Preferably, the pivot links 206, 210, 214 are suitable for tolerating movements other than just rotation around the pivot axis, while said other movements are of small amplitude, so as to be able to accommodate the machining allowances.

The jack 204 is preferably, as shown, a pneumatic jack. To that end, the jack 204 has a first compressed air inlet 216, for the deployment of the piston 210 outside the cylinder 208, and a compressed air inlet 218, for the retraction of the piston 210 inside the cylinder 208. Said inlets 216, 218 are fluidly connected to a compressed air supply system (not shown).

Thus, when the jack 204 is deployed, this drives the movement of the arm 200 in the transverse direction Y, in a first direction. Because of its connections 206 with the connecting rods 202, the movement of the arms 200 drives the rotation of the connecting rods 202 around the second rotation axes 190, said connecting rods 202 simultaneously driving the rotation of said second rotation axes 190 around their axes, in the second direction, and therefore the movement of the second needles 184 from the retracted position toward their deployed position. The pivot links 206 of the arm 200 with the connecting rods 202 force the movement of the arm 200 upward, then downward at the same time that it moves along the transverse direction Y; this movement is tolerated by the jack 204 owing to the pivot links 212, 214.

When, on the contrary, the jack 204 retracts, this drives the movement of the arm 200 in the transverse direction Y, in a second direction opposite the first direction. Because of its connections 206 with the connecting rods 202, the movement of the arms 200 drives the rotation of the connecting rods 202 around the second rotation axes 190, said connecting rods 202 simultaneously driving the rotation of said second rotation axes 190 around their axes, in the first direction, and therefore the movement of the second needles 184 from the deployed position toward their retracted position. Again, the pivot links 206 of the arm 200 with the connecting rods 202 force the movement of the arm 200 upward, then downward at the same time that it moves along the transverse direction Y, this movement still being tolerated by the jack 204 owing to the pivot links 212, 214.

The first driving device 192 being symmetrical to the second driving device relative to a vertical axis of symmetry, the deployment of its jack 204 drives the rotation of the first rotation axes 198 not in the second direction, but in the first direction, here also allowing the deployment of the first needles 182, and the retraction of said jack 204 drives the rotation of the first rotation axes 198 not in the first direction, but in the second direction, here also allowing the retraction of the first needles 182.

The gripping head 102 also comprises a cleaning circuit for the circulation of a cleaning fluid inside the gripping head 102, said cleaning circuit being adapted so that, without disassembling the body 110, the cleaning fluid can circulate in all of the cavities inside the body 110 and thus ensure satisfactory cleaning of the body 110.

This cleaning circuit comprises the guiding system 160. Indeed, by bringing a cleaning fluid through the coupling 168, the cleaning fluid can easily circulate in the entire guiding system 160 and leave through the second windows 154, cleaning them on the same occasion.

The cleaning circuit also comprises an intake pipe 220 for supplying cleaning fluid to parts of the body 110 other than just the guiding system 160. This pipe 220 emerges through an outer orifice, not visible in the Figures, outside the body 110, in particular in an upper face 221 of the body 110, and through an inner orifice, not shown, inside the cavity 187; thus, when cleaning fluid is brought through the intake pipe 220, the latter spreads in the cavity 187, cleaning the inside of this cavity 187, and in particular the needles 182, 184 positioned inside this cavity 187. The fluid can next be discharged through the first windows 152, cleaning them as it passes.

Preferably, the cleaning circuit also comprises, as shown, an outlet pipe 222 for discharging the cleaning fluid outside said other parts of the body 110. Like the pipe 220, this pipe 222 emerges through an outer orifice, not visible in the Figures, outside the body 110, in particular in the upper face 221 of the body 110, and through an inner orifice, not shown, inside the cavity 187; thus, any overflow of cleaning product in the cavity 187 can emerge through the outlet pipe 222.

The cleaning circuit further comprises stoppers 224 to close off the orifices of the pipes 220, 222 during normal operation of the gripping head 102. These stoppers 224 are suitable for being removed during the cleaning of the gripping head 102.

A method for producing deformable food products using the facility 2 will now be described, in reference to FIGS. 2 to 11.

The method first comprises a step for providing a sheet 24 of the first food material using the supply station 22 and a roll 28 of the second food material using the supply system 26. This supply step is followed by a step for wrapping the sheet 24 around the roll 28 using the wrapping station 32, then a step, carried out using the cutting station 38, for cutting the roll 28 and the sheet 24 wrapped around into segments 39, the central segments 39 of which form the deformable food products. This cutting step is also followed by a step for driving the food products using the driving and separating device 40, then a step for moving the food products using the gripping device 100.

For the supply, wrapping, cutting and driving steps, the reader is invited to see the description of the steps given by document FR 2,996,988 A1, the content of which is incorporated herein by reference.

During the movement step, the food products are moved from the belts of the driving and separating device 40 into trays (not shown) advantageously having a cellular bottom for packaging thereof. To that end, the movement step comprises the following successive sub-steps.

First of all, during a first sub-step for moving the head 102, the robotic arm 104 brings the head 102 into the gripping position, such that at least a portion of the receiving surfaces 130 defined by the perforated plates 112 is arranged above the food products carried by the belts of the driving and separating device 40, at a small distance from the latter, for example flush with them. Advantageously, each of said receiving surfaces 130 is arranged above a respective food product after the movement of the head 102 by the arm 104.

Next, during a gripping sub-step, the jack 204 of each of the first and second driving devices 192, 194 is deployed. In so doing, as described above, the first and second needles 182, 184 of each pair are deployed; when the receiving surface 130 with which this pair is associated is positioned above a food product, the needles 182, 184 thus penetrate in said first food product and raise this food product toward the receiving surface 130.

Then, during a second sub-step for moving the head 102, the robotic arm 104 moves the head 102 away from the driving and separating device 40 and brings the head 102 above the packaging trays for the food products. The food products selected by the deployed needles 182, 184 are thus moved simultaneously.

Lastly, during a step for releasing the food products, the jack 204 of each of the first and second driving devices 192, 194 is retracted. In so doing, as described above, the first and second needles 182, 184 of each pair retract, thus releasing any food product retained by said needles 182, 184. At the same time, pressurized gas, in particular pressurized air, is blown through the through orifices 140 using the blowing system, so as to loosen the food products that may have stuck to their receiving surface 130. At the same time, the head 102 performs a quick horizontal translational movement so as to cause the food products to abut against the walls of the cells of the packaging trays and to thus cause a shearing force at the interface between the food products and their respective receiving surfaces 130 that contributes to the loosening of any stuck food products. The food products thus released, and if applicable loosened, are then deposited in the trays, where they will be able to be packaged.

Thus, owing to the invention described above, it is possible to grip and move deformable food products while damaging the gripped products very little. Indeed, the method for gripping food products avoids deforming or flattening these products, despite their fragility, and avoids unwrapping the first food product.

Furthermore, the invention does not require suction, it limits dirtying of the gripping device 100 used to that end, and therefore the contamination of the food products relative to one another, as well as the number of cleaning operations of the gripping head 102. By doing without suction, the invention also limits the noise level caused by the use of the gripping device 100.

It is further particularly easy to ensure the maintenance of said gripping device 100, in particular the disassembly and the cleaning of the gripping head 102 of this device 100.

Lastly, the invention allows effective gripping of the food products even in case of significant variability of these food products in terms of dimensions, shapes and/or grammage, and even when the food products presented for gripping are insufficient in number relative to the gripping capacity of the device 100.

All of these advantages result in a reduced number of manipulations necessary at the line output and significant gains in productivity.

1.-16. (canceled)

17. A gripping device for at least one deformable food product, comprising:
at least one perforated plate defining at least one receiving surface for the deformable food product, and
for the or each receiving surface, a pair of needles associated with said receiving surface, each needle of said pair being able to be moved between a retracted position, in which the needle does not pass through the receiving surface, and a deployed position, in which the needle passes through the receiving surface.

18. The gripping device according to claim 17, wherein the receiving surface is convex.

19. The gripping device according to claim 17, comprising a blowing system able to blow gas through the or each receiving surface.

20. The gripping device according to claim 19, wherein the or each perforated plate has, for the or each receiving surface defined by said perforated plate, at least two through orifices each emerging in said receiving surface, each needle of the pair associated with this receiving surface extending, when it is in the deployed position, through a respective through orifice among said through orifices.

21. The gripping device according to claim 20, wherein the blowing system is able to blow air through said through orifices.

22. The gripping device according to claim 20, wherein the blowing system comprises, for each receiving surface, at least one blowing nozzle emerging near through orifices emerging in said receiving surface

23. The gripping device according to claim 22, wherein each blowing nozzle has a diameter smaller than 5 mm.

24. The gripping device according to claim 22, wherein the blowing system comprises a pressurized gas supply system, able to supply a gas at a pressure of between 1 bar and 3 bars.

25. The gripping device according to claim 24, wherein the pressurized gas supply system is able to supply a gas at a pressure of between 1 bar and 2.5 bars.

26. The gripping device according to claim 22, wherein the receiving surfaces are a plurality, at least one blowing nozzle being positioned substantially equidistant from a first through orifice emerging in a first of said receiving surfaces and a second through orifice emerging in a second of said receiving surfaces.

27. The gripping device according to claim 22, wherein the or each receiving surface is elongated along a main direction, and the blowing nozzles comprise at least two blowing nozzles framing, along a direction orthogonal to the main direction, the through orifices emerging in said receiving surface.

28. The gripping device according to claim 17, wherein each needle is mounted rotating around a rotation axis relative to the perforated plate between its retracted and deployed positions, each needle further being in the shape of an arc of circle centered on said rotation axis.

29. The gripping device according to claim 28, wherein the rotation axes of the two needles of a same pair are substantially parallel to one another, the rotation direction of a first needle of the pair from its retracted position toward its deployed position being opposite the rotation direction of the second needle of the pair from its retracted position to its deployed position.

30. The gripping device according to claim 28, wherein there is a straight line substantially parallel to the rotation axes of the needles of a same pair such that, when said needles are in the deployed position, this line passes through said needles.

31. The gripping device according to claim 17, wherein each needle has a diameter smaller than or equal to 5 millimeters

32. The gripping device according to claim 17, wherein each needle has a diameter smaller than or equal to 2 millimeters.

33. A facility for producing deformable food products each comprising an outer envelope made from a first food product and an inner filling made from a second food product, the facility comprising:
a station for supplying a sheet of first food material,
a system for supplying a roll of second food material,
a station for wrapping the sheet around the roll,
a station for cutting the roll and the sheet wrapped around into a plurality of segments each forming a deformable food product, and
a station for packaging deformable food products, comprising a gripping device according to claim 17 for gripping deformable food products and depositing said deformable food products into containers.

34. A method for moving a deformable food product using a gripping device according to claim 17, characterized in that it comprises the following successive steps:
bringing a receiving surface above the deformable food product,
deploying the pair of needles associated with the receiving surface, the needles penetrating into the deformable food product,
moving the gripping device, and
retracting said pair of needles.

35. The method for moving a deformable food product according to claim 34, wherein the deformable food product comprises an outer envelope made from a first food product and an inner filling made from a second food product.
